(19) United States
(12) Patent Application Publication
(10) Pub. No.: US 2020/0155278 A1
(43) Pub. Date: May 21, 2020

(54) LOW PROFILE SELF-LIGATING ORTHODONTIC BRACKET

(71) Applicant: John C. Voudouris, Toronto (CA)

(72) Inventor: John C. Voudouris, Toronto (CA)

(21) Appl. No.: 16/442,033

(22) Filed: Jun. 14, 2019

Related U.S. Application Data
(63) Continuation of application No. 15/236,145, filed on Aug. 12, 2016, now abandoned.
(60) Provisional application No. 62/204,082, filed on Aug. 12, 2015.

(51) Int. Cl. A61C 7/28

(52) U.S. Cl. CPC A61C 7/287

(57) ABSTRACT

A low-profile self-ligating orthodontic bracket having a body and a locking shutter. The body may include, a base portion and a pair of laterally spaced occlusal tie wings projecting in a generally labial direction from the base portion. At least one of the occlusal tie wings includes a projecting column. The body may further include a shutter guiding portion, a portion of which is located occlusally beyond a projecting column. The body also has an archwire slot for accepting an archwire. The shutter engages with the body for movement between a closed position, in which the shutter covers a sufficient portion of the archwire slot to prevent the archwire from exiting the slot, and an open positon, in which the archwire can exit the slot. The shutter includes a lingual portion that is movably engagable with the shutter guiding portion of the body.

### CROSS-REFERENCE TO RELATED APPLICATION

This application is a continuation of U.S. application Ser. No. 15/236,145 (now pending), filed Aug. 12, 2016 which application claims the benefit of the filing date under 35 USC 119(e) of United States Provisional Application entitled “Low Profile Self-Ligating Orthodontic Bracket,” Ser. No. 62/204,082 (now expired), filed Aug. 12, 2015, the entire contents of which are incorporated herein by reference.

### BACKGROUND OF THE INVENTION—FIELD OF THE INVENTION

The present invention relates generally to the field of orthodontics and, more specifically, to the field of orthodontic bracket assemblies.

### BACKGROUND OF THE INVENTION—DESCRIPTION OF THE PRIOR ART

According to established orthodontic techniques, it is well known to attach an orthodontic bracket assembly to a patient's tooth. The bracket assembly provides a location for attaching an archwire and other orthodontic devices to facilitate movement of the tooth. It is well known to ligate an archwire to the orthodontic bracket assembly utilizing an elastic or metal ligature. In conventional orthodontic bracket assemblies, the ligature is wrapped around respective gingival and occlusal tie wings so as to overlay the archwire at mesial and distal ends of the orthodontic bracket assembly.

Recently, designers have created self-ligating bracket assemblies that do not require a separate ligature for attachment of the archwire to the bracket assembly. One type of self-ligating bracket assembly is supplied with a locking shutter that is movable between an open position, permitting access to the archwire slot, and a closed position, inhibiting access to the archwire slot. Self-ligating bracket assemblies substantially decrease the time involved in performing ligation procedures.

Some versions of these self-ligating brackets include a shutter with a lingual portion that would utilize an occlusal-gingival, lingual vertical slot that traveled completely under the archwire slot when in the closed position. The existence of this so-call “through-and-through” vertical slot requires the bracket body to have a certain height to accommodate the slot. Such self-ligating brackets are described in U.S. Pat. No. 6,368,105, the disclosure of which is incorporated in its entirety herein.

To reduce the height of the bracket body, subsequent versions of self-ligating brackets used lingual slots that were not completely flat, but instead include an angled slot to accept the lingual portion of the shutter. Such self-ligating brackets are described in U.S. Pat. No. 8,636,507, the disclosure of which is incorporated in its entirety herein. These brackets, however, provide little vertical travel distance for the lingual portion of the shutter, which may lead to less stability and control over the shutter than with the “through-and-through” slots.

### SUMMARY OF THE INVENTION

In one of its aspects, this invention may provide, for example, a self-ligating orthodontic bracket having a body and a locking shutter. The body may include a base portion; a pair of laterally spaced occlusal tie wings projecting in a generally labial direction from the base portion, with at least one of the occlusal tie wings including a generally labially projecting column; a shutter guiding portion, a portion of which being located occlusally beyond the projecting column; and an archwire slot for accepting an archwire. The shutter may engage with the body for movement between a closed position in which the shutter covers a sufficient portion of the archwire slot to prevent the archwire from exiting the slot and an open positon in which the archwire can exit the slot. The shutter may include a shutter support that is movably engagable with the shutter guiding portion of the body.

In certain embodiments, at least a portion of the archwire slot is bounded on one side by at least a portion of the occlusal tie wings. The shutter guiding portion of the body may include a channel in located at least in part occlusally beyond the projecting column. The shutter support may include at least one arm member movably received in the channel. In certain embodiments, the shutter support arm is received substantially only in a portion of the channel located occlusally beyond the projecting column when the shutter is in the open positon. The shutter support arm may also be received in a portion of the channel located lingual to the projecting column when the shutter is in the closed positon.

In certain embodiments, the shutter guiding portion of the body includes a guide arm projecting occlusally beyond the projecting column. Additionally, the shutter support may include a channel for movably receiving the guide arm of the shutter guiding portion.

In certain embodiments, the body of the self-ligating orthodontic bracket of the present invention may also include a pair of laterally spaced gingival tie wings projecting in a generally labial direction from the base.

In another aspect, the present invention is directed to a self-ligating orthodontic bracket having a body and a shutter. The body may include a pair of laterally spaced gingival tie wings and a pair of laterally spaced occlusal tie wings, with at least one of the occlusal tie wings having a generally labially projecting column that may include a lower projection extending occlusally therefrom. The lower projection may include a channel therein that is located, at least in part, occlusally beyond the projecting column. The body may also include an arch wire slot extending in a mesiodistal direction across the body and between the gingival and occlusal tie wings to accommodate an arch wire. The shutter may be in engagement with the body for movement between a closed position in which the shutter covers a sufficient portion of the archwire slot to prevent the archwire from exiting the slot, and an open positon in which the archwire can exit the slot. This engagement includes a lower, or lingual, portion of the shutter being at least partially movably received in a portion of the channel of the lower projection.

In another aspect, the present invention is directed to a self-ligating orthodontic bracket having a body, a shutter, and a shutter guiding portion. The body may include a base portion; a pair of laterally spaced occlusal tie wings projecting in a generally labial direction from the base, at least one of the occlusal tie wings having a generally labially projecting column; and an archwire slot for accepting an archwire. The shutter may be in engagement with the body for movement between a closed position in which the shutter covers a sufficient portion of the archwire slot to prevent the archwire from exiting the slot and an open positon in which the archwire can leave the slot. This engagement may include the shutter having a shutter support that is movably engaged with the shutter guiding portion of the body. The shutter guiding portion may be attached to the body, with at least a portion of the shutter guiding portion being located occlusal to the projecting column.

In certain embodiments, the orthodontic bracket may also include a mounting pad, wherein the body may be attached to the mounting pad. The shutter guiding portion may be attached to the body by being attached to the pad.

### BRIEF DESCRIPTION OF THE DRAWINGS

FIG. 1 is a perspective view of an embodiment of the presently described self-ligating bracket.

FIG. 2 is a perspective view of the embodiment shown in FIG. 1 with the shutter in the open position.

FIG. 3 is a cross-sectional view along line A-A of the bracket body and shutter of the embodiment shown in FIG. 1 with the shutter in the closed position and with a circular archwire.

FIG. 4 is a cross-sectional view along line A-A of the bracket body and shutter of the embodiment shown in FIG. 1 with the shutter in the closed position and with a rectangular archwire.

FIG. 5 is a cross-sectional view along line B-B of the bracket body and shutter of the embodiment shown in FIG. 2.

FIG. 6 is a front view from the occlusal side of the bracket of the embodiment shown in FIG. 1.

### DESCRIPTION OF CERTAIN PREFERRED EMBODIMENTS OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “attached,” “mounted,” “connected,” “supported,” and “coupled” and variations thereof are used broadly and encompass both direct and indirect mountings, connections, supports, and couplings. Further, “attached,” “connected,” and “coupled” are not restricted to physical or mechanical attachments, connections, or couplings.

Referring now to the drawings, wherein the reference characters designate identical or corresponding part throughout the several views and embodiments.

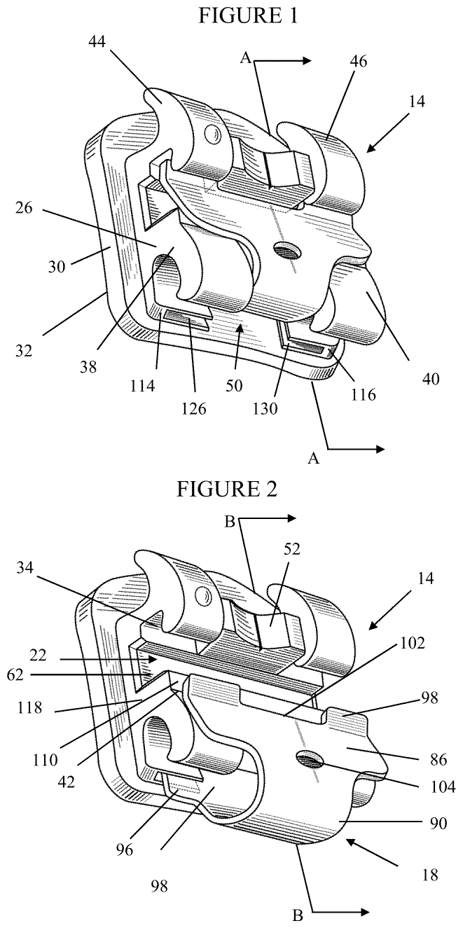

As depicted in FIGS. 1-6, an embodiment of the presently described self-ligating bracket includes a bracket 14 and a clip or locking shutter 18. The illustrated bracket 14 includes a bracket body 26 and a base 30. The bracket body 26 includes an archwire slot 22 extending along a mesiodistal direction, receiving areas 34, first and second laterally spaced occlusal tie wings 38, 40, first and second laterally spaced gingival tie wings 44, 46, and an occlusal-gingival opening 54 extending therebetween. As described in more detail below, a vertical slot 50 is located underneath the gingival tie wings 44, 46. The occlusal tie wings 38, 40, as shown, may also include a labial resting groove 42 on the labial surface 110 of the occlusal tie wings 38, 40.

The illustrated shutter 18 may include a labial portion 86, an intermediate portion 90, and a lingual portion 94. The labial portion 86 may have substantially the same mesiodistal width as the body 26 and includes a labial end 98 and a notch 102. In certain embodiments, the labial portion 86 may also include a circular cut-out 104 that extends through the shutter 18 and receives a tool, i.e., an opening tool (not shown), that may be used to move the shutter 18 between the open position and the closed position. In other constructions, the cut-out may be different shapes and may not extend through the shutter 18.

As shown in FIGS. 1 and 2, the bracket 14 has a closed position (FIG. 1) in which the shutter 18 inhibits access to the archwire slot 22, and an open position (FIG. 2) in which the shutter 18 allows access to the archwire slot 22 to allow placement of an archwire. The labial resting groove 42 may be engaged by the shutter 18 while in the open position. In the illustrated embodiment, the labial resting groove 42 forms a concave surface that interfaces with a convex surface 106 of the labial end 98 of the shutter 18. In other constructions, the labial resting groove may be formed using other surfaces and shapes.

The illustrated base 30 connects the bracket 14 to a tooth (not shown) and includes a bonding pad 32 that receives an adhesive and is shaped to affix to the tooth. In the illustrated embodiment, the lingual side of the bonding pad 32 affixes to the labial side of the tooth. The base 30 may be attached to the body 26 with welds. In other embodiments, the base 30 may be attached in other ways or formed as a single piece with the body 26.

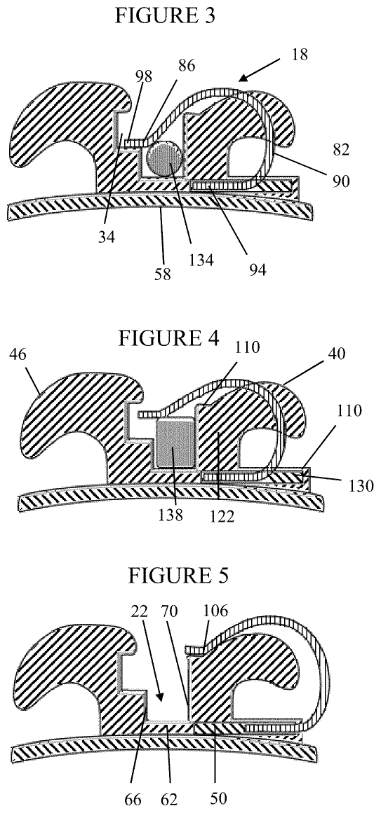

The illustrated archwire slot 22 may be defined by a lingual surface 62, a gingival side surface 66, and an occlusal side surface 70. With reference to FIGS. 3 and 4, the archwire slot 22 may be sized to receive an archwire 134 having a circular cross-section or an archwire 138 having a rectangular cross-section. Once the archwire is seated, the archwire slot 22 inhibits movement of the archwire in the lingual, gingival, or occlusal directions, and the shutter 18 may be used restrict movement of the archwire in the labial direction when the shutter is in the closed position. As shown in FIG. 4, the design of the shutter 18 is such that the rectangular archwire 138 is seated to apply torque to the archwire slot 20 depending on the rectangular cross-sectional shape of the archwire 138. The continuous active seating or biasing of the archwire 138 by the shutter 18 allows for accurate tooth movement.

The receiving areas 34 are defined in a gingival portion of the body 26 and, as depicted in FIGS. 1 and 2, may include a first receiving area 34 separated from a second receiving area 34 by the protrusion 52. The first receiving area 34 extends labially and gingivally from the gingival side surface 66 to one of the mesial or distal sides of the body 26. The second receiving area 34 extends labially and gingivally from the gingival side surface 66 to the other of the mesial or distal sides of the body 26. The protrusion 52 separates the first receiving area and the second receiving area and is gingivally even with the gingival side surface 66. The protrusion 52 functions to inhibit the archwire from entering the receiving areas 34 and interfering with the labial end 98 of the shutter 18 when the shutter 18 is in the closed position.

In the illustrated embodiment, the pair of occlusal tie wings 38, 40 are formed on the occlusal portion of the body 26 and provides a place for ligation bands or wire (not shown) to be wrapped for functional or aesthetic purposes. The first and second occlusal tie wings 38, 40 project labially from the body and include first and second column portions 118, 122 respectively. While the illustrated embodiment depicts a pair of occlusal tie wings 38, 40, alternative embodiments of the presently described bracket may feature a single occlusal tie wing.

Opposite the archwire slot, the illustrated pair of gingival tie wings 44, 46 are formed on a gingival portion of the body 26 and, like the occlusal tie wings 38, 40, provides a place for ligation bands or wire to be wrapped for functional or aesthetic purposes. As with the occlusal tie wings, while the illustrated embodiment depicts a pair of gingival tie wings 44, 46, alternative embodiments featuring a single gingival tie wing are also contemplated.

The labial end 98 of the shutter 18 is curved labially to form a convex surface 106 that rests on the labial surface 110 of the occlusal tie wings 38, 40 when the shutter 18 is in the open position. The notch 102 is defined in the labial end 98 of the shutter 18 and receives the protrusion 52 when the shutter 18 is in the closed position such that the shutter 18 is stabilized in the mesiodistal direction. In other constructions, the labial portion 86 of the shutter may be different shapes or have different mesiodistal widths. In addition, the convex surface 106 and the labial end 98 may be different shapes or may be straight sections. Furthermore, the labial end 98 may define more than one notch 102 or less than one notch 102 and the body 26 may include more than one protrusion or less than one protrusion to be received in the notches in the labial end 98.

In the illustrated embodiment, the intermediate portion 90 of the shutter 18 connects the labial portion 86 to the lingual portion 94 and has a narrower mesiodistal width than the labial portion 86 such that the intermediate portion 90 fits between the first and second occlusal tie wings 38, 40. As shown in FIGS. 1 and 2, the lingual portion 94 of the shutter 18 has two arm members 96 that function extend the mesiodistal width of the lingual portion 94. As described in more detail below, the arm members 96 are sized to be received in the guiding portions 114, 116. In some embodiments, the lingual portion 94 of the shutter 18 may be mildly divergent, or curved, at its end to allow a catching or stop of the shutter at the bottom of the guiding portions 114,116. In an alternative embodiment, the guiding portions 114, 116 may also include L-shaped ends to prevent the shutter 18 from inadvertently falling out.

With reference to FIGS. 1-6, in the illustrated embodiment, the shutter guiding portions 114, 116 extend occlusally beyond the columns 118, 122 of the occlusal tie wings 38, 40. As shown, the shutter guiding portions 114, 116 may extend from the respective column 118, 122 and reach almost to the occlusal end of the bonding pad 32 that is attached to the tooth. As shown in the figures, guiding slots 126, 130 may be formed in the shutter guiding portions 114, 116 and extend gingivally in to the columns 118, 122 such that the slots 126, 130 are located lingual to the columns 118, 122. While the shutter guiding portions 114, 116 are depicted in the figures as being a part of the body, in other embodiments, the shutter guiding portions 114, 116 may be separate from the body 26. In these alternative embodiments, the shutter guiding portions 114, 116 may be attached to the body 26 by virtue of being attached to the same bonding pad 32.

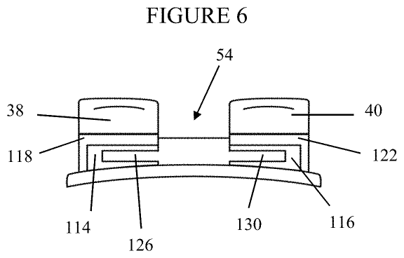

As shown in FIGS. 3-5, the occlusal ties wings 38, 40 feature a C-shaped re-curve. Unlike prior art brackets, the shutter guiding portions 114, 116 of the vertical slots, and the slots 126, 130 present therein, allow for externalized shutter travel. As depicted, the presently described brackets provide a vertical slot 50 that does not extend behind, or lingual to, the archwire slot. FIGS. 3 and 4 depict the shutter 18 in the closed position, and FIG. 5 shows the shutter in the open position. The transition between these two positions is permitted by the lingual portion 94, and specifically the arm members 96, of the shutter 18 travelling through the slots 126, 130 in the guiding portions 114, 116. By externalizing the vertical guide slot in the shutter guiding portions 114, 116, the vertical slot 50 no longer has to run underneath the archwire slot 22, resulting in the ability to make the bracket 14 have a lower profile if desired, as shown in FIG. 6.

In operation, the bracket 14 is attached to the tooth with the attachment portion 58. The shutter 18 is moved to the open position with the labial end 98 of the shutter 18 disposed on top of the labial surface 110 of the occlusal tie wings 38, 40 and the lingual portion 94 of the shutter 18 disposed in the occlusal ends of the slots 126, 130 of the shutter guiding portions 114, 116. In this position, the shutter 18 is substantially free of contact with the gingival ties wings 44, 46, and does not inhibit access to the archwire slot 22. The appropriate archwire may then be seated into the archwire slot 22, and the shutter 18 may be moved from the open position to the closed position such that the labial end 98 of the shutter 18 leaves the labial surface 110 of the occlusal tie wings 38, 40, and the lingual end 94 travels in a gingival direction through the slots 126, 130 of the shutter guiding portions 114, 116. The labial portion 86 of the shutter 18 is moved over the archwire and archwire slot 22 and into the closed position such that the labial end 98 of the shutter 18 is disposed within the receiving area 34 and the lingual end 94 is disposed further within the slots 126, 130 of the shutter guiding portions 114, 116, such that the lingual end 94 of the shutter 18 is positioned in the lingual portions of the first and second column portions 118, 122 of the occlusal tie wings 38, 40. Once in the closed position, the shutter 18 inhibits the archwire from moving in the labial direction such that the archwire slot 22 and the shutter 18 cooperate to inhibit the movement of the archwire in the labial, lingual, occlusal, and gingival directions.

All of the apparatus and methods disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A self-ligating orthodontic bracket comprising:
(a) a body comprising:
(i) a base portion;
(ii) a pair of laterally spaced occlusal tie wings projecting labially from said base, wherein at least one of said occlusal tie wings comprises a generally labially projecting column;
(iii) a shutter guiding portion, wherein at least a portion of said shutter guiding portion extends occlusally from said projecting column; and
(iv) an archwire slot extending in a mesiodistal direction across the body to accommodate an archwire; and
(b) a shutter in engagement with said body and movable between a closed position, wherein said shutter covers a sufficient portion of said archwire slot to prevent said archwire from exiting said archwire slot, and an open positon, wherein said archwire can exit said archwire slot, said shutter comprising a shutter support movably engaged with said shutter guiding portion of said body.

2. The self-ligating orthodontic bracket of claim 1, wherein at least a portion of said archwire slot is bounded on one side by at least a portion of said occlusal tie wings.

3. The self-ligating orthodontic bracket of claim 1, wherein said shutter guiding portion of said body comprises a channel that extends at least in part occlusally from said projecting column.

4. The self-ligating orthodontic bracket of claim 3, wherein said shutter support comprises at least one shutter support arm member movably received in said channel.

5. The self-ligating orthodontic bracket of claim 4, wherein said shutter support arm member is received substantially only in a portion of said channel located occlusally beyond said projecting column at least when said shutter is in the open positon.

6. The self-ligating orthodontic bracket of claim 4, wherein said shutter support arm member is received in a portion of said channel located lingual to said projecting column when said shutter is in the closed positon.

7. The self-ligating orthodontic bracket of claim 1, wherein said shutter guiding portion of said body comprises at least one guide arm projecting occlusally from said projecting column.

8. The self-ligating orthodontic bracket of claim 7, wherein said shutter support comprises a channel for movably receiving said at least one guide arm.

9. The self-ligating orthodontic bracket of claim 1, wherein said body further comprises a pair of laterally spaced gingival tie wings projecting labially from said base.

10. The self-ligating orthodontic bracket of claim 1, wherein said at least one of said occlusal tie wings comprises each of said occlusal tie wings.

11. A self-ligating orthodontic bracket comprising:
(a) a body comprising:
(i) a pair of laterally spaced gingival tie wings;
(ii) a pair of laterally spaced occlusal tie wings, at least one of said occlusal tie wings comprising a labially projecting column, said projecting column comprising a lower projection extending occlusally therefrom, said lower projection comprising a channel therein, said channel being located at least in part occlusally beyond said projecting column;
(iii) an archwire slot extending in a mesiodistal direction across the body and between the gingival and occlusal tie wings to accommodate an archwire; and
(b) a shutter in engagement with said body and movable between a closed position, wherein said shutter covers a sufficient portion of said archwire slot to prevent said archwire from exiting said archwire slot, and an open positon, wherein said archwire can exit said archwire slot, said engagement including a lingual portion of said shutter being at least partially movably received in a portion of said channel.

12. The self-ligating bracket of claim 11, wherein said lingual portion of said shutter is received substantially only in a portion of said channel located occlusally beyond said projecting column at least when said shutter is in the open positon.

13. The self-ligating bracket of claim 11, wherein said lingual portion of said shutter is received in a portion of said channel located lingual to said projecting column when said shutter is in the closed positon.

14. A self-ligating orthodontic bracket comprising:
(a) a body having:
(i) a base portion;
(ii) a pair of laterally spaced occlusal tie wings labially projecting from said base, at least one of said occlusal tie wings comprising a generally labially projecting column; and
(iii) an archwire slot extending in a mesiodistal direction across the body to accommodate an archwire;
(b) a shutter guiding portion attached to said body, wherein at least a portion of said shutter guiding portion is located occlusally from said projecting column; and
(b) a shutter in engagement with said body and movable between a closed position, wherein said shutter covers a portion of said archwire slot to prevent said archwire from exiting said archwire slot, and an open positon, wherein said archwire can exit said archwire slot, said engagement including said shutter having a shutter support member movably engaged with said shutter guiding portion.

15. The self-ligating orthodontic bracket of claim 14, wherein said base comprises a bonding pad, wherein said body is attached to said bonding pad.

16. The self-ligating bracket of claim 15, wherein said shutter guiding portion is attached to said body by being attached to said boding pad.

17. The self-ligating orthodontic bracket of claim 14, wherein said body further comprises a pair of laterally spaced gingival tie wings.
